(19) United States
(12) Patent Application Publication
(10) Pub. No.: US 2024/0146088 A1
(43) Pub. Date: May 2, 2024

(54) MOTIVE POWER ELECTRICAL ENERGY STORAGE SYSTEMS AND METHODS

(71) Applicant: Enatel, Christchurch (NZ)

(72) Inventors: Anton Clark, Christchurch (NZ); Murray Wyma, Christchurch (NZ)

(21) Appl. No.: 18/568,517

(22) PCT Filed: Jun. 10, 2021
(86) PCT No.: PCT/NZ21/50092

§ 371 Date: Dec. 8, 2023

(51) Int. Cl. H02J 7/02; H02J 3/38; H02J 7/34

(52) U.S. Cl. CPC H02J 7/02; H02J 3/381; H02J 7/34; H02J 2207/20; H02J 2300/20

(57) ABSTRACT

A battery charging system includes a direct current (DC) bus and a plurality of battery chargers connected to the DC e bus. Each of the plurality of battery chargers is configured to: electrically connect to a first battery having a first nominal voltage and supply first direct current (DC) power from the DC bus to the first battery at the first nominal voltage to charge the first battery. Each of the plurality of battery chargers is further configured to electrically connect to a second battery having a second nominal voltage different from the first nominal voltage and supply second direct current (DC) power from the DC bus to the second battery at the second nominal voltage to charge the second battery.

### FIELD OF THE DISCLOSURE

The present disclosure generally, relates to storing energy using batteries and more particularly to management of energy storage using a plurality of different batteries of different types or batteries at different stages of their respective cycle lives.

### BACKGROUND

A battery charging system including a plurality of battery chargers, each configured to charge one or more types of batteries, may be deployed at a single site. The site may be one at which a plurality of chargeable batteries are used, or one from which a plurality of battery-powered devices, such as electric vehicles, are deployed. The site may receive electrical power from a utility provider.

### SUMMARY

An illustrative system includes a direct current (DC) bus and a plurality of battery chargers connected to the DC bus. Each of the plurality of battery chargers is configured to electrically connect to a first battery having a first nominal voltage. Each of the plurality of battery chargers is further configured to supply first direct current (DC) power from the DC bus to the first battery at the first nominal voltage to charge the first battery. Each of the plurality of battery chargers is further configured to electrically connect to a second battery having a second nominal voltage different from the first nominal voltage. Each of the plurality of battery chargers is further configured to supply second direct current (DC) power from the DC bus to the second battery at the second nominal voltage to charge the second battery.

An illustrative method of operating a battery charging system including a plurality of battery chargers configured to receive power from a direct current (DC) bus includes receiving, by a controller in communication with a first battery charger of the plurality of battery chargers, a charge state of a battery connected to the first battery charger. The method further includes determining, by the controller based on the charge state, that the battery is at less than a full charge level. The method further includes transmitting, by the controller based on the determination that the battery is at less than the full charge level, a charge signal to the first battery charger configured to cause the first battery charger to charge the battery. The DC bus has a first nominal voltage and the battery has a second nominal voltage different than the first nominal voltage. The first battery charger is configured to receive first direct current (DC) power at the first nominal voltage from the DC bus, convert the first DC power to a second direct current (DC) power at the second nominal voltage, and output the second DC power to the battery.

Another illustrative method of operating a battery charging system including a plurality of battery chargers configured to output power to a direct current (DC) bus includes receiving, by a controller in communication with a first battery charger of the plurality of battery chargers, a charge state of a battery connected to the first battery charger. The method further includes determining, by the controller based on the charge state, that the battery at a charge level sufficient to output power to the DC bus. The method further includes transmitting, by the controller based on the determination that the battery is at the charge level, a discharge signal to the first battery charger configured to cause the first battery charger to discharge the battery. The first battery has a first nominal voltage and the DC bus has a second nominal voltage different than the first nominal voltage. The first battery charger is configured to receive first direct current (DC) power at the first nominal voltage from the battery, convert the first DC power to a second direct current (DC) power at the second nominal voltage, and output the second DC power to the DC bus.

### BRIEF DESCRIPTION OF THE DRAWINGS

FIG. 1 is a diagrammatic view of an example battery charging and electrical energy storage system compatible with a plurality of battery types, in embodiments.

FIG. 2 is a flow chart illustrating an example method for charging a plurality of battery types using a battery charging and electrical energy storage system, in embodiments.

FIG. 3 is a flow chart illustrating an example method for determining that an electric vehicle (EV) battery should be used as a stationary battery in a battery charging and electrical energy storage system, in embodiments.

FIG. 4 is a flow chart illustrating an example method for determining that a stationary battery should be taken out of use in a battery charging and electrical energy storage system, in embodiments.

FIG. 5 is a flow chart illustrating an example method for determining how to charge and/or discharge batteries of a battery charging and electrical energy storage system, in embodiments.

FIG. 6 is a diagrammatic view of an example of a computing environment, in embodiments.

### DETAILED DESCRIPTION

The following disclosure of example methods and apparatus is not intended to limit the scope of the detailed description to the precise form or forms detailed herein. Instead the following disclosure is intended to be illustrative so that others may follow its teachings.

At certain sites, a large number of batteries may be used, for example, as a source of power for motive power equipment, including electric vehicles (EVs) such as forklifts. Such sites may include warehouses, department stores, manufacturing facilities, or any other sites where materials are handled. While forklifts are are merely one use of batteries, batteries may be used for other types of EVs and/or may be used for other purposes than EVs. Batteries at such a site may be charged using battery chargers, so that the batteries may be reusable. A site may also have more batteries than can fit on the battery chargers of a site alone or may be used in the EVs alone, so that some batteries may be used in the EVs while others charge using the battery chargers, ensuring that if a battery in an EV runs low on power, another battery that is charged may be swapped out with the battery in the EV to keep the EV running.

As such, sites with many EVs and/or many other uses for batteries may have a significant amount of batteries. Described herein are methods and systems for using batteries of a site as an electrical energy storage system (FESS) in combination with bi-directional battery charger systems, so that batteries may be charged and/or used as energy storage for site power or output to a power grid as desired according to the systems and methods described herein. For example, batteries as described herein may store energy that may be used to charge other batteries, supply power to mains of a site or facility, supply power to a power grid, etc. Similarly, battery charging and electrical energy storage systems and methods described herein may be use grid power, renewable power source(s) on site, or other batteries to charge batteries, such as those used to power EVs.

Advantageously, the systems and methods described herein may accommodate different types of batteries (e.g., batteries with different nominal voltages, different sizes, different capacities, etc.), including batteries at different stages in their respective life cycles. In other words, batteries of different types that have more or less useful life left may all be used in the battery charging and electrical energy storage systems and methods described herein. Such systems and methods are more versatile with respect to energy storage systems that use a set of identical batteries or battery cells, and that may keep those batteries or cells on a same life cycle. In addition, such systems and method as described herein advantageously accommodate the typical usage of motive power batteries and other types of batteries that may be recharged and used for other purposes than just for energy storage (e.g., for electric vehicles (Ely's)). Batteries that are recharged, removed from a charger, and then placed back on a charger after use may be used at different rates and may have unique replacement schedules based on their individual use. Accordingly, the systems and methods described herein advantageously provide for a battery charging system to which batteries of different types and life cycles may be removably attached, while also optionally being used for energy storage for charging other batteries, powering site mains, and/or exporting power to a power grid.

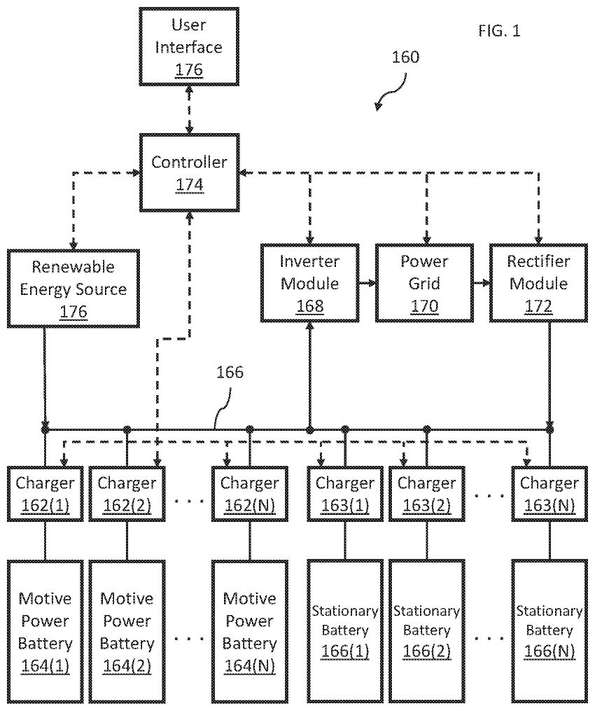

Referring now to the drawings, wherein like numerals refer to the same or similar features in the various views, FIG. 1 is a diagrammatic view of an example battery charging and electrical energy storage system 160 compatible with a plurality of battery types, in embodiments. In particular the system includes a direct current (DC) bus 166 to which a plurality of chargers 162(1), 162(2), . . . 162(N) (which may be referred to herein collectively as the chargers 162 or individually as the charger 162) and a plurality of chargers 163(1), 163(2), . . . 163(N) (which may be referred to herein collectively as the chargers 163 or individually as the charger 163).

The chargers 162 and 163 are configured to connect to batteries to charge or discharge batteries to which they are connected. In particular, the chargers 162 may be connected to motive power batteries 164(1), 164(2), . . . 164(N) (which may be referred to herein collectively as the batteries 164 or individually as the battery 164, and may also be referred to herein as electric vehicle (EV) batteries). The chargers 163 may be connected to stationary batteries 166(1), 166(2), . . . 166(N) (which may be referred to herein collectively as the stationary batteries 166 or individually as the stationary battery 166). The motive power batteries 164 may also be referred to herein as motive batteries, as they may be used to provide power to locomotive vehicles such as forklifts, electric lifts, electric cars or trucks, or any other type of EV. While the systems and methods described herein refer to batteries as the motive power batteries 164 and the stationary batteries 166, the batteries described herein may be used for and/or designed for any purpose, including for non-EV uses. Additionally, while the stationary batteries 166 may typically be semi-permanently connected to their respective one of the chargers 163, the stationary batteries 166 may still be removed from their chargers 163. Further, the stationary batteries 166 may be similar to or the same as one or more of the motive power batteries 164 but may have reached a point in its life cycle where it no longer useful to power an EV. Thus, a motive power battery may be designated a stationary battery after it is no longer useful as a motive power battery for an EV. As such, the stationary batteries 166 may, in some embodiments, be similar to or the same as the motive power batteries 164.

Accordingly, the system 160 may include motive power batteries 164 that are regularly charged using the chargers 162, removed from the chargers 162, used in EVs or for other purposes, and then reconnected to the chargers 162 to charge the motive power batteries 164 again. In various embodiments, the chargers 162 may also be used to discharge the batteries 164 as described further herein. The stationary batteries 166 may be permanently or semi-permanently connected to the chargers 163. In this way, the stationary batteries 166 may not be removed often or at all for use in an EV or other for another use outside of the system 160. As such, the stationary batteries 166 may be charged using the chargers 163 and may be discharged using the chargers 163.

Both the chargers 162 and the chargers 163 may supply DC power from the DC bus 166 to the batteries 164 and the batteries 166, respectively. The chargers 162 and the chargers 163 may be configured as DC to DC converters or some other type of charger that is able to charge batteries of different types (e.g., batteries of different nominal voltages). In other words, the chargers 162 and the chargers 163 may detect a nominal voltage of a battery connected thereto (e.g., one of the batteries 164 or 166), receive DC power from the DC bus 166, and output power to a batter connected thereto at the nominal voltage of the battery. In this way, the DC bus 166 may supply power at a different voltage than the nominal voltage of one or more of the batteries 162 and/or 163, and the chargers 164 and 166 may supply power at nominal voltages of the batteries 162 and/or 163. For example, a DC bus 166 may provide power at a first nominal voltage, while the motive power battery 164(1) has a second nominal voltage different from the first nominal voltage of the DC bus 166 and the motive power battery 164(2) may have a third nominal voltage different from both of the first and second nominal voltages. The charger 162(1) may convert the DC power received from the DC bus 166 at the first nominal voltage to power at the second nominal voltage to output to the motive power battery 164(1), while the charger 162(2) may convert the DC power received from the DC bus 166 at the first nominal voltage to power at the third nominal voltage to output to the motive power battery 164(2). The charger 162(1) may also convert DC power to the second nominal voltage to charge the motive power battery 164(2) and/or may output power at the first nominal voltage to a battery that is rated for the first nominal voltage. In other words, the chargers 162 of FIG. 1 may be able to output DC power of any number of varying nominal voltages to charge different types of batteries having a plurality of nominal voltages.

Similarly, the chargers 163 may also receive DC power from the DC bus 166 and output voltage to various batteries at any of the first, second, or third nominal voltages, or any nominal voltage of a particular battery that is connected to one of the chargers 163. In this way, the system 160 is flexible in that any battery may be attached to any charger, and the charger may determine a nominal voltage of a battery and charge the battery accordingly.

In addition, each one of the chargers 162 and 163 may discharge a battery connected thereto. In doing so, the chargers 162 and 163 may again be or may act similar to a DC to DC converter, by receiving power from a given battery at its nominal voltage, converting the power to a nominal voltage of the DC bus 166 (if necessary), and outputting the DC power at the nominal voltage of the DC bus 166 to the DC bus 166. In this way, the chargers 162 and 163 may output or supply power to the bus 166 from various types and nominal voltages of batteries as described further herein.

In various embodiments, the nominal voltages of the batteries 164 and 166 may vary, and may differ from or be the same as a nominal voltage of the DC bus 166. For example, the chargers 164 and 166 may accommodate batteries with nominal voltages anywhere within a nominal voltage ranges of 12 to 96 volts (V) or any other range of voltages. For example, nominal voltages of batteries that the chargers 162 and 163 may charge or discharge may include nominal voltages of 12 V, 24 V, 36 V, 48 V, 60 V, 72 V, 80 V, 96 V, etc. In some embodiments, higher nominal voltage batteries may also be accommodated including up to 800 V or higher, such as 200 V, 300 V, 350 V, 375 V, 800 V batteries as may be found in electric automobiles. The batteries 164 and 166 may also be of different types and/or chemistries. For example, any one of the batteries 164 and/or 166 may be a lead acid type battery, a lithium ion type battery, or any other type of battery.

In various embodiments, some or all of the chargers 162 and 163, as well as the DC bus 166 may be in a charging cabinet where batteries may be connected to the chargers 162 and/or 163 and charged. In some embodiments, the chargers 162 and 163 may have different physical connection mechanisms for connecting to batteries, while in other embodiments the chargers 162 and 163 may have the same physical connection mechanisms for connecting to batteries and/or may have the same internal components as well. For example, the chargers 162 may have physical connectors that are more easily removable from a battery to facilitate removable of the motive power batteries 164 for use in an EV. In such an example, the chargers 163 may have physical connectors that facilitate a permanent or semi-permanent connection with the stationary batteries 166, as the stationary batteries 166 may not be removed on a regular (e.g., daily, weekly, monthly) basis, but may rather be removed and replaced on a more infrequent basis (e.g., hi-monthly, sub-annually, annually, etc.). In other words, while the motive power batteries 164 may be removed often to be used in other devices or systems than the system 160, the stationary batteries 166 may remain connected to the system 160 as their primary usage is within the system 160.

The system 160 may also include a renewable energy source 176, which may represent one or more renewable energy sources, such as solar, geothermal, wind, or other renewable energy sources that may be installed at a site where the chargers 162 and 163 are used and/or where the motive power batteries 164 are used in Ed's. An input may be located at the bus 166 to input energy from the renewable energy source 176 into the bus 166. In other words, the renewable energy source 176 may be electrically connected to the DC bus 166 so that DC power may be input to the DC bus 166 from the renewable energy source 176. In some embodiments, the renewable energy source 176 may produce AC power and the renewable energy source 176 may include an AC to DC converter so that DC power may be input to the DC bus 166.

In this way, power from the renewable energy source 176 may be input to the DC bus 166 and used to charge one or more of the batteries 164 and/or 166 that are connected to the chargers 162 and 163. If the renewable energy source 176 is located at the same site as the chargers 162 and 163 energy generated by the renewable energy source 176 may therefore be used to charge one or more of the batteries 164 and/or 166 without the power generated by the renewable energy source 176 being output to a wider power grid, such as a power grid 170 of the system 160.

This may be useful where, for example, the renewable energy source 176 include solar panels and EVs at a site are operated during daylight hours. In such an example, the renewable energy source 176 may generate the most power during the day when the sun is shining, and may charge the stationary batteries 166 and any motive power batteries 164 that are not currently in use in EVs at the site. However, if the site is active (e.g., people working and using EVs on site such as forklifts) during the day, several of the motive power batteries 164 may not be available for charging while power generated from the renewable energy source 176 is at its highest level. Thus, the energy generated by the renewable energy source 176 may be stored in the stationary batteries 166, and then the energy stored in the stationary batteries 166 may be used to charge one or more of the motive power batteries 164 when they are no longer in use at the site (e.g., at night when the site is not active or is less active, but while the renewable energy source 176 may be producing less power).

The system 160 may further include an inverter module 168 configured to receive third DC power from the DC bus 166, convert the DC power to AC power, and output the AC power to the power grid 170. In some embodiments, the AC power may additionally or alternatively be output to AC mains or a main power supply of the site at which the battery chargers 162 and/or 163 are located. In other words, power converted to AC power from the DC bus 166 by the inverter module 168 may also be output to site mains so that other AC power consuming devices on the site may use power drawn from the DC bus 166 (e.g., from the batteries 164 and/or 166, from the renewable energy source 176, etc.). As such, the batteries 164 and/or 166 as well as the renewable energy source 176 may be used to feed power to AC mains at a site where the system 160 and any of the methods described herein are implemented.

The system 160 also includes a rectifier module 172 configured to receive AC power from the power grid 170 (e.g., via an AC main power supply of the site at which the system 160 is used). The rectifier module 172 may convert the AC power received from the power grid 170 into DC power to be output to the DC bus 166. In this way, power from the power grid 170 may be used to charge the batteries 164 and 166 via the chargers 162 and 163 and the DC bus 166.

The system 160 also includes a controller 174, which may include a processor for executing instructions stored on a computer memory to implement the various methods described herein. The dashed lines in FIG. 1 indicate connections to components for sending control signals between the various components of the system 160, while the solid lines represent connections for transmitting power between components of the system 160. In other words, the controller 174 may communicate with any of the renewable energy source 176, the chargers 162 and 163, the inverter module 168, the rectifier module 172, and a user interface 176.

The controller 174 may communicate with the chargers 162 and 163, for example, to cause one or more of the chargers 162 and/or 163 to charge or discharge one or more of the batteries 164 and 166 according to the various embodiments for charging and discharging batteries described herein. In other words, the controller 174 may control when the batteries 164 and 166 are charged or discharged.

In formation may also be communicated between the chargers 162/163 and the controller 174. For example, the chargers 162 and 163 may detect a presence of a battery when a battery is connected to a respective charger and communicate a presence of such a battery to the controller 174 so the system is aware when batteries are connected. The chargers 162 and 163 may further measure or detect various characteristics of batteries and communicate those characteristics to the controller 174. For example, the chargers 162 and 163 may detect a charge level of batteries connected thereto, nominal voltages of the batteries, actual voltage of the batteries, amperage of the batteries, ampere hours remaining of the batteries, size of the batteries, temperature of a battery, electrolyte level of a battery, and/or any other characteristic of a battery that may indicate a state of the battery, battery type, or its state of charge. The chargers 162 and 163 may also measure characteristics of the batteries connected to over time and may also communicate such data along with timestamps to the controller 174 (or the controller 174 may timestamp data as it is received) so that the state of batteries and their respective state of charges may be monitored over time (e.g., as a battery is charged or discharged). In this way, the controller 174 may determine and monitor various aspects of the batteries 164 and 166. Such information may be used in part, for example, to determine when certain batteries should be charged or discharged, when power should be output to the power grid 170, when power from the grid 170 and/or the renewable energy source 176 is used to charge batteries, etc.

In various embodiments, one or more of the batteries 164 and/or 166 may be a serial bus-controlled battery. The serial may be any type of protocol, including, but not limited to, a Controller Area Network (CAN) bus protocol, Modbus protocol, etc. Thus, charging of the batteries 164 and/or 166 may be controlled using a serial protocol. In such example embodiments, a CAN bus connection or other type of connection may be made between a given battery's battery management system and its respective battery charger. Thus, any charging information/instructions or other electronic signals relating to how the battery is charged, as well as any measurements related to a battery, may be communicated between a battery, its charger, and a controller using CAN bus, Modbus, etc.

The controller 174 may also communicate with and/or control the renewable energy source 176 to receive information about power being generated by the renewable energy source 176. For example, communications from the renewable energy source 176 may indicate to the controller 174 how much power is being generated by the renewable energy source 176. To the extent the renewable energy source 176 has controllable components (e.g., to turn on/off generation of power and/or adjust a level of power output by the renewable energy source 176), the controller 174 may also send communications to the renewable energy source 176 to control the renewable energy source 176.

The controller 174 may also be in communication with and/or control the inverter module 168 to control when power is drawn from the DC bus 166 to output to the power grid 170. For example, power may be discharged from the batteries 164 and/or 166 to output power to the power grid 170 via the inverter module 168. In another example, power from the renewable energy source 176 may be controlled to be output to the power grid 170 via the inverter module 168.

The controller 174 may also be in communication with the and/or control the rectifier module 172 to control when and how much power is drawn from the power grid 170 to output to the DC bus 166. Such DC power may be used, for example, to charge any of the batteries 164 and/or 166 as desired.

Controller 174 may also be in communication with or may include a demand response module (DRM) or demand response unit (DRU) (not shown in FIG. 1). A DRM may be used to monitor and/or adjust energy usage of a site or specific device by monitoring usage of power and comparing such usage to demand for power in general (which impacts price of power). In other words, a DRM may receive and transmit to the controller 174 information about the price of drawing power from the power grid 170 to the DC bus 166 in real time. Such pricing data may be received from a utility company computing device, for example. In this way, the controller 174 may decide how to use power from the power grid 170 or output power to the grip 170 using pricing information. The function of the DRM or DRU may be represented by the dashed line between the controller 174 and the power grid 170 in FIG. 1. In other words, the DRM or DRU facilitates the sharing of information between the power grid 170 and the controller 174 as described herein.

The DRM may also be used to monitor usage of power at the site at which the system 160 is used. Such power usage may include power usage of the system 160 itself and may include other power usage at the site where the system 160 is used. In this way, the controller 174 may receive communications related to power usage of devices or equipment elsewhere at the site where the system 160 is located. Such information may be useful so that the controller 174 may direct additional power (e.g., from the batteries 164 and/or 166, from the renewable energy source 176) to AC mains of the site as power usage of other equipment or devices at the site increases or is expected. A DRM may also indicate to the system if there are any current or expected reliability issues for the power grid 170. In such instances, the controller 174 may direct power usage (e.g., for charging) to happen at a time that does not coincide with reliability issues, and may direct power output (e.g., from discharging batteries) to occur at times that coincide with those reliability issues. In this way, the usage of power at a site may be managed in a way that responds to wider supply/demand of a power grid and also available or needed energy at the site where the system 160 is used.

In various embodiments, an alternating current (AC) bus may be used instead of or in addition to the DC bus 166 of FIG. 1, However, each of the battery chargers 162 and 163 may then include a rectifier to convert AC power from the AC bus to DC power for battery charging (and an inverter may be included in each charger for battery discharging). In other words, each charger would function as an AC to DC converter (and vice versa for discharging). In such an embodiment, the inverter module 168 and the rectifier module 172 may be omitted, as power may be output or input to the AC bus from the power grid 170 or an AC main of a site without converting the power between AC and DC.

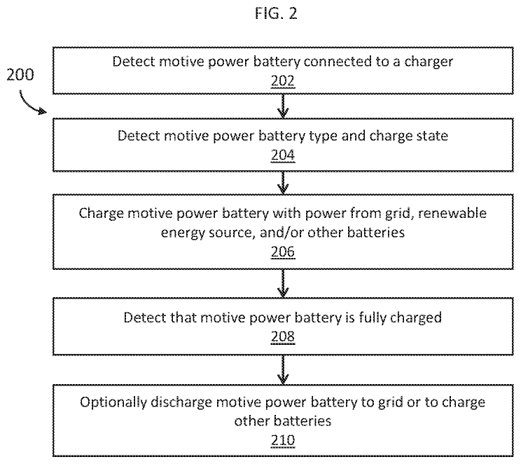

FIG. 2 is a flow chart illustrating an example method 200 for charging a plurality of battery types using a battery charging and electrical energy storage system, in embodiments. At an operation 202, an electric vehicle (EV) battery is detected at a charger. At an operation 204, the battery type and charge state of the motive power battery may be detected. The motive power battery may be or may function similarly to, for example, any one of the motive power batteries 164 of FIG. 1, and the charger may be or may function similarly to, for example, any one of the chargers 162 or 163 of FIG. 1. Detecting that the motive power battery is connected to a charger may include measuring battery characteristics (e.g., nominal voltages of the batteries, actual voltage of the batteries, amperage of the batteries, ampere hours remaining of the batteries, size of the batteries, any other characteristic of a battery that may indicate a state of the battery, battery type, or its state of charge) and transmitting those characteristics to a controller. The controller may be or may function similarly to, for example, the controller 174 of FIG. 1. Accordingly, the controller may determine that a motive power battery is connected to the charger based on the information detected about the battery by the charger and transmitted to the charger. In various embodiments, the charger may determine that the battery attached to the charger is a motive power battery, and transmit information about the battery type (e.g., EV or stationary) to the controller. In other words, either the controller or the charger may determine a battery type connected to the charger.

In various embodiments, the detection that a motive power battery is connected to a charger at the operation may be made based on a designation of the charger the battery is connected to. For example, in some embodiments, a first set of chargers (e.g., the chargers 162 of FIG. 1) may be designated for charging motive power batteries and a second set of chargers (e.g., the chargers 163 of FIG. 1) may be designated for charging stationary batteries. As such, the system may detect a motive power battery connected to a charger based on whether the battery is connected to the one of the first set of chargers or the second set. In various embodiments, the battery and/or a component permanently or semi-permanently attached to the battery may have an electronic component that may be read by the charger to which it is attached to identify the battery, and what type of battery it is. For example, a battery or connector on the battery may include an electronic communication module that may communicate with the charger using power line carrier (PLC) communications. As such, the charger and controller may identify a battery type, track specific batteries over time, etc.

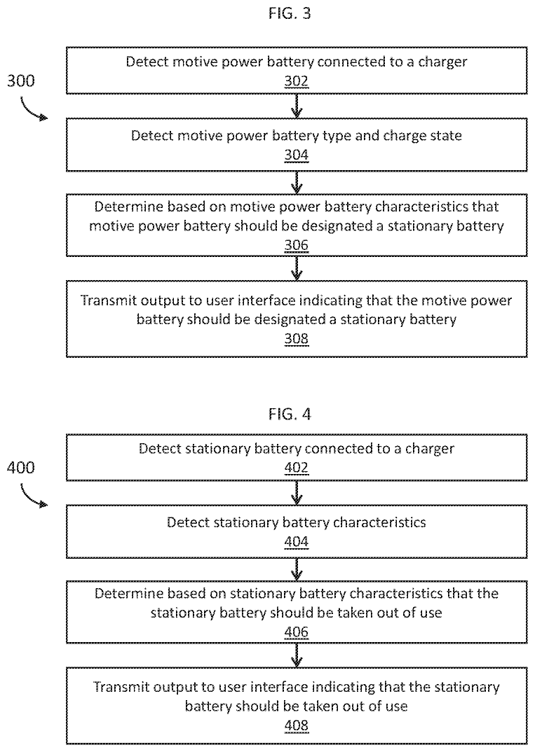

In any event, the system may determine whether to consider a battery connected to a charger as a motive power battery or a stationary battery as described herein. In this way, the system may better determine how to charge or discharge a battery. In addition, as discussed further with respect to FIGS. 3 and 4 discussed below, the system may also determine whether the designation for a battery (e.g., motive power battery, stationary battery, etc.) should change. In addition, while motive power batteries are used as examples herein, the motive power batteries may be any type of batteries that are removed from the chargers for use and placed back on the chargers for charging and may not necessarily be used for electric vehicles (EVs). As such, in various embodiments, the motive power battery designation may represent that the battery is regularly removed from the chargers for discharge by another use or device than through the discharge systems described herein. Accordingly, the controller may determine itself or receive information related to various information of any batteries connected to the chargers, such as battery type, size, charge state, etc. In doing so, the controller may determine based on the charge state that the battery is at less than a full charge level.

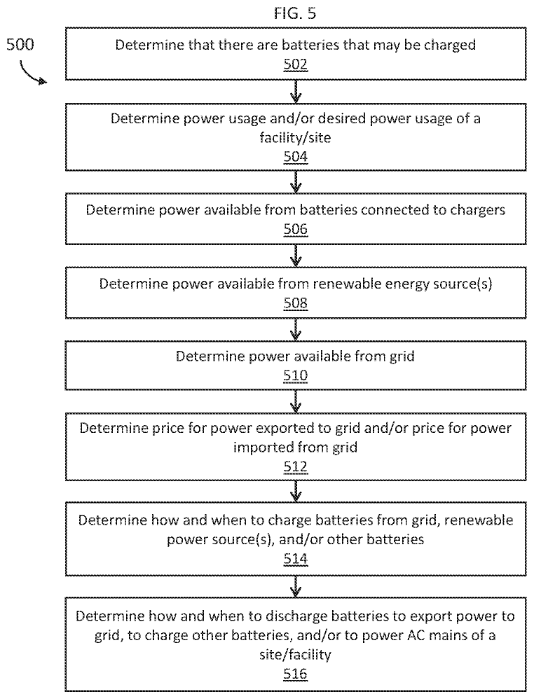

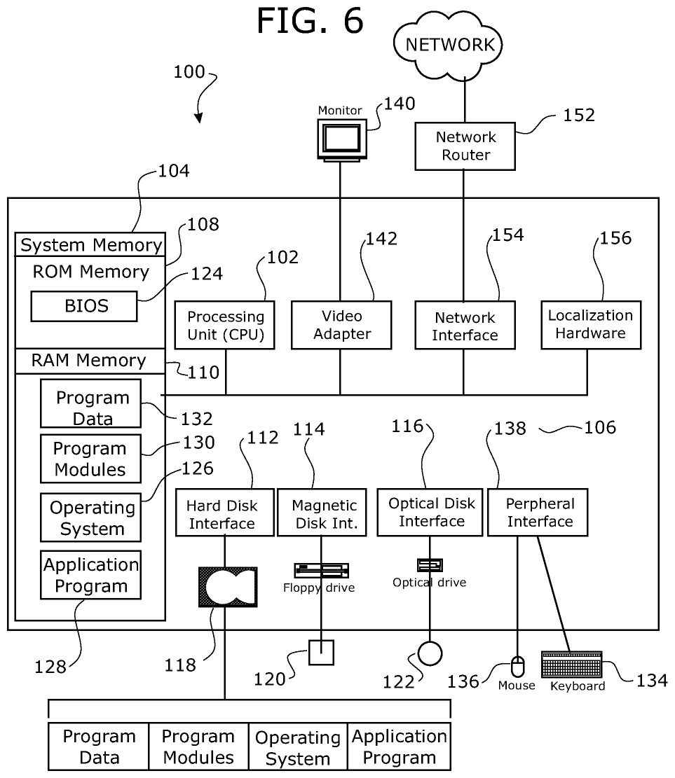

If the motive power battery is at a less than a full charge (or less than a predetermined threshold charge considered to be a full charge), the motive power battery is charged at an operation 206 with power from a power grid, a renewable energy source, and/or other batteries as described herein. The system may prioritize charging motive power batteries, because the system may expect that motive power batteries will be used again relatively soon (e.g., in an EV). The system may determine where to source the power for charging the motive power batteries based on a number of factors. Some examples of how the system may determine when and how to charge a battery are discussed below with respect to FIGS. 5 and 6. The charging may be accomplished by, for example, transmitting, from the controller to a charger based on the determination that the battery is at less than the full charge level, a charge signal to the battery charger configured to cause the battery charger to charge the battery. As discussed herein, chargers may charge batteries of different nominal voltages by acting as a DC to DC converter to convert voltage from a DC bus to a battery at the correct voltage to charge a battery without damaging the battery. The nominal voltage of the batteries may therefore also be the same as or different from a nominal voltage of the DC bus.

At an operation 208, the system may detect that the motive power battery is fully charged (or has reached a predetermined threshold of charge considered to be frilly charged). The controller of the system may transmit a signal to the charger instructing the charger to stop charging the battery. In various embodiments, the charger itself may identify that the battery has reached a full charge and stop charging the battery. In various embodiments, the fully charged threshold for a battery may also vary depending on where in a battery's cycle life the battery is. As such, the controller may determine that a battery is at less than a full charge or at a full charge based on battery type, charge state, or any other characteristic of a battery measured/detected at the operation 204.

At an operation 210, the motive power battery may be optionally discharged to a power grid or to charge other batteries connected to the system. For example, if a motive power battery is not removed from its charger for a predetermined amount of time (e.g., within 4 hours, 8 hours, 12 hours, 18, hours, 24 hours, 36 hours, 48 hours, etc.), during a particular time window of day (e.g., if not removed between 6-9 AM, between 5-8 PM, etc.), or the motive power battery is left on a charger over one or more weekend days, the motive power battery may be discharged as desired to a power grid or to charge other batteries connected to the system. This may be advantageous where, for example, the motive power battery is no longer being used regularly or the motive power battery is not likely to be used again within an amount of time it would take to discharge and then recharge the motive power battery. For example, if a motive power battery is not removed from its charger in the time window of 6-9 AM on a weekday, the system may presume that the motive power battery will not be used during a particular shift, and may discharge and recharge the battery before the system expects the battery will be used again. In such an example, the system may output to a user interface (e.g., indicator lights, a screen, the user interface 176 of FIG. 1, etc) that the battery should not be removed or that the battery is not ready for use. This may occur even if the battery has a high charge level, because the system is planning to discharge the battery.

Similar to motive power batteries in the method 200, characteristics of stationary batteries may also be detected and/or measured by chargers. Characteristics such as a charge state may be measured, and chargers may transmit charge state information of stationary batteries to the controller of the system. In this way, the controller may receive information about batteries that have a sufficient charge that may be discharged as desired and as described herein. In other words, the system and its controller may monitor charge states of any batteries connected to the system, whether the batteries are considered motive power batteries, stationary batteries, any other designation, so that the batteries may be charged and/or discharged as desired without, for example, the system mistakenly attempting to discharge a battery that does not have a sufficient charge for discharging or does not have a threshold of charge desired for discharging. If the battery is determined to have a charge level sufficient to output power to the DC bus, a signal may be sent to the charger from the controller to discharge the battery. As with charging the batteries, the chargers may act as DC to DC converters to convert power from the battery's nominal voltage to the nominal voltage of the DC bus to output power at the appropriate voltage to the DC bus.

FIG. 3 is a flow chart illustrating an example method 300 for determining that an electric vehicle (EV) battery should be used as a stationary battery in a battery charging and electrical energy storage system, in embodiments. At an operation 302, a charger and or controller detects that a battery is connected to a charger.

At an operation 304, the charger detects a battery type, charge state, and any other information about a battery connected to a charger (e.g., as detected in the operation 204 of FIG. 2). In other words, the charger may detect characteristics of a battery, and that battery characteristic information may be transmitted from a charger to a controller.

At an operation 306, the controller or charger determines, based on the battery characteristic information, that the first battery should no longer be used as an electric vehicle (EV) battery. In other words, the controller may determine that the characteristics of a battery indicates that the battery should no longer be removed from a charger and used in an EV, For example, the characteristics may indicate that a battery has reached a point in its cycle life where it can no longer hold a desired charge for a certain length of time that is desirably for use in an EV or other use in which the battery is removed from the charger. As such, the system may a determine that the battery should be designated as a stationary battery and be permanently or semi-permanently attached to one of the chargers.

At an operation 308, the controller or charger may transmit, to a user interface, a signal indicative of the determination that the first battery should no longer be used as the motive power battery. The user interface may be or may function similarly to the user interface 176 shown in and described above with respect to FIG. 1. In other words, the system may output in some way information that the motive power battery should no longer be removed to be used in an EV or other use. Such an alert or output may include instructions for moving the battery to a different charger (e.g., moving the battery from one of the chargers 162 to one of the chargers 163 of FIG. 1). In various embodiments, an alert or output may include a light or other indicator instructing a user not to remove the battery from the charger to which it is connected so that the battery will no longer be inadvertently placed in and used in an EV. A signal or alert indicating that a battery should now be used as a stationary battery may also be output to another computing device, such as a smartphone, laptop, desktop computer, tablet, etc. so that a user may see which batteries have outlived their use as a motive power battery for EVs.

In various embodiments, the controller may also identify particular batteries and monitor their characteristics over time. For example, how far a battery has progressed into its cycle life may be easier to determine if the controller has received information about that battery's characteristics over time through multiple charges. As such, the controller and/or charger of the system may receive charge state and/or other battery characteristics at different times from one or more different chargers related to the same battery. The controller may use this information gathered over time to determine when a battery should be characterized as a stationary battery instead of a motive power battery, or even when a stationary battery should be removed and disposed of (as discussed further below with respect to FIG. 4).

FIG. 4 is a flow chart illustrating an example method 400 for determining that a stationary battery should be taken out of use in a battery charging; and electrical energy storage system, in embodiments. At an operation 402, the charger and/or controller may detect that a stationary battery is connected to a charger. The operation 402 may be similar to the operations 202 and/or 302 of FIGS. 2 and 3 described above. Where a stationary battery is connected to a charger, the system may detect that the battery is connected when it is first connected to the charger and may not need to detect it again, as the battery will stay connected to the charger for a long period of use as a stationary battery. In some embodiments, a user input may be received that designates a battery as a stationary or non-stationary (e.g., a motive power battery as described herein), so that the system knows to treat a battery as stationary or non-stationary (at least initially when the battery is connected). In this way, the system can in some way detect that a battery that should be regarded as a stationary battery is connected. The categorization of a battery as stationary may be advantageous because then the system is able to know that the battery will not be disconnected for use in an EV or for some other use. In various embodiments, a battery may be physically locked to a charger when it is designated as a stationary battery to prevent its removal or disconnection from a charger.

At an operation 404, battery characteristics of the stationary battery are detected. The detection of battery characteristics may be similar to the detection of battery characteristics performed in the operations 204 and/or 304 discussed above and shown in FIGS. 2 and 3. In other words, the system may measure the charge state, voltage, current into and/or out of the battery, etc. of a battery. The system may also determine where in the battery's cycle life the battery is, either through characteristics measured at a discrete point in time or through monitoring a battery's characteristics over time as described herein.

At an operation 406, the system may determine based on the measured characteristics of the battery that it should be removed from the charger and taken out of use and/or disposed of. In other words, when a battery reaches a point in its cycle life when it is unable to hold a useful charge, the system may determine that the battery should be removed and taken out of use.

At an operation 408, a second signal indicative of the determination that the battery should no longer be used as a stationary battery is transmitted to a user interface or otherwise output to a user. For example, the user input may be any type of input described above with respect to the operation 308 of FIG. 3 and/or the user interface 176 of FIG. 1. As such, the user may be informed that the battery should be removed from the chargers.

FIG. 5 is a flow chart illustrating an example method 500 for determining how to charge and/or discharge batteries of a battery charging and electrical energy storage system, in embodiments. In particular, the method 500 demonstrates at least some of the factors and inputs that may be used by the system to determine when and how to charge or discharge batteries that are part of an electrical energy storage system (FESS) as described herein, such as the system shown in and described with respect to FIG. 1 above. At an operation 502, the system determines that there are batteries (or at least one batten) that may be charged. In other words, the system determines or detects that there are batteries connected to chargers that are at less than a full charge. The operation 502 may be similar to or the same as the operations 202, 204, 302, 304, 402, and/or 404 of FIGS. 2-4 described herein.

Operations 504, 506, 508, 510, and 512 discussed below describe possible factors that may be used in determining how and when to charge or discharge batteries connected to the system. Some, none, or all of the factors described herein with respect to the operations 504, 506, 508, 510, and 512 may be used in various embodiments to determine when and how to charge or discharge batteries. Operations 514 and 516 of FIG. 5 describe actually charging or discharging the batteries of a system based on the factors described with respect to the operations 504, 506, 508, 510, and/or 512. However, specific examples of how the factors of the operations 504, 506, 508, 510, and 512 may be used to charge (e.g., the operation 514) or discharge (e.g., the operation 516) the batteries are described along with each of the operations 504, 506, 508, 510, and 512 rather than aggregated in descriptions of the operations 514 and 516. Accordingly, the operations 504, 506, 508, 510, and/or 512 may be relevant to either, both, or none of the operations 514 and 516 in various embodiments.

At an operation 504, the system determines power usage and/or desired power usage of a facility or site. The power usage and/or desired power usage determined may be based on inputs received from one or more information sources. For example, the inputs may be manually input by a user using a computing device (e.g., via the user interface 176 of FIG. 1 or another computing device that is in communication with the controller of the system). The inputs may also come from other devices, such as devices that monitor power usage of an entire facility/site, power usage of a particular piece of equipment at the facility/site, power usage of a particular type (e.g., lighting, heat), or any other type of device that may monitor and track power usage.

In various embodiments, the controller may receive inputs about power usage of the site and record or save the information along with timestamps related to the usage, so that power usage patterns over time may be determined. In various embodiments, such power usage patterns over time may be determined by other devices than the controller of the system, and those devices may transmit those patterns to the controller. In still further embodiments, the controller and/or other devices may use the power usage patterns over time information to predict how power is likely to be used in the future. The future predicted use of power may be used to determine how to charge/discharge batteries. For example, knowing that power usage spikes during a first time window of a day (or particular day of the week) or that power usage is relatively low during a second time window of a day (or particular day of the week) may inform how the batteries are charged or discharged. Batteries may be charged in advance of time windows in which spikes in power usage is likely, may be discharged during those spikes in power usage, and/or may be charged when power usage is relatively low. In this way, the system may prepare for particular time windows when certain power usage patterns are likely.

The power usage patterns may also include tracking, by the controller of the system, when motive power batteries are connected and disconnected from the system. The controller may be configured to adjust the charging/discharging patterns of stationary and/or motive power batteries based on how many motive power batteries are being charged at a given time and/or how many motive power batteries are not connected to chargers at a given time. The system may further track use of the motive power batteries over time based on when the motive power batteries are connected to the chargers, to predict when motive power batteries are likely to be in use in the future. Such information may be used to control the chargers to ensure that motive power batteries are fully charged in advance of time windows in which it is expected that the motive power batteries will be in use. For example, if a motive power battery is placed onto a charger at the end of an 8 AM to 5 PM shift (so the battery is placed on the charger about 5 PM), the system may know from past use that the motive power battery is not likely to be used again and removed from the charger until between 7 AM and 8 AM the next morning. If the motive power battery may be charged, for example, in 7 hours, the controller may wait until midnight to start charging the motive power battery. Such a system may be advantageous where, for example, power from the grid costs more in the hours between 5 PM and midnight than from the hours of midnight to 7 AM on a typical day. Accordingly, the system may adjust when batteries are charged based on expected usage, as well as other factors such as anticipated power grid pricing and demand (e.g., as also described with respect to the operation 512).

At an operation 506, the system determines how much and/or whether power is available from batteries connected to chargers. For example, stationary or other batteries connected to chargers may have stored power thereon that may be used to discharge for various purposes as described herein. For example, charged batteries may output power for exporting to the grid, for powering devices on site by exporting power to AC mains of the site/facility, and/or for charging other batteries connected to various chargers of the system. By determining how much power is available from already charged batteries, the system can determine what might be powered using the already charged batteries. The system may also determine whether some charged battery power is not available for discharge. For example, a motive power battery that is fully charged and connected to a charger may not be available for discharge if it is expected or assumed that the motive power battery will be removed for use in an EV. As such, when determining available power from charged batteries at the operation 506, the system may exclude from such a determination one or more motive power batteries.

At an operation 508, power available from one or more renewable energy source(s), such as the renewable energy source 176 of FIG. 1, is determined. The system may therefore take into account the amount of power available from the renewable energy sources) in determining how to charge or discharge batteries connected to the system, output energy from the renewable energy source(s) to a grid, and/or output energy from the renewable energy source(s) to AC mains of a site/facility for use on site. For example, the system may use renewable energy source(s) as opposed to grid power whenever possible to charge batteries, may use renewable energy source(s) to power AC mains when power usage of the site it high, etc. Like other aspects described herein with respect to the operation 504, the system may also track and monitor power production of renewable energy source(s). In this way, the system may learn when renewable energy sources) are producing power and how much. The system may also receive information related to factors that impact renewable energy source(s) (e.g., how much sunlight will be present for solar power, how much wind will be present for wind power, etc.). Accordingly, the system may predict how much renewable energy may be produced at a given time of day given various factors such as the type of renewable energy resource, weather, etc.

At an operation 510, power available from a grid is determined. For example, the operation 510 may include determining if there is an outage on the power grid, if unreliable power is being provided by the grid, or if there are otherwise limits on power that may be drawn from the grid. The system may use such information to decide how to charge or discharge the batteries of the system. For example, if there is an outage, the system may use the batteries with stored energy to power AC mains of the site to keep power at the site. In some embodiments, reduced power available on the grid may be preplanned by a utility company. As such, the controller of the system may receive information from another computing device regarding planned outages or interruptions in service or reduced amounts of power available at particular times. As such, the controller may be able to plan for certain outages or reduced power being supplied to a site from the grid. The controller may plan accordingly by ensuring that as many batteries as possible (e.g., all of the stationary batteries connected to the system) are charged so as to provide power to the site and/or to charge motive power batteries when the planned outage occurs.

At an operation 512, a price for power exported to the grid and/or a price for power imported from the grid is determined. The prices for exported and/or imported power may be received from a device, such as a demand response module (DRM) or other device that transmits information related to pricing of available power from the grid and/or the price paid for power delivered to the grid. In this way, the controller may account for pricing of power (either for importing or exporting) in determining how to charge or discharge batteries.

At an operation 514, the system determines how and when to charge batteries as described herein. For example, batteries connected to chargers may be charged using power from a power grid, renewable power source(s), and/or other batteries. At an operation 516, the system determines how and when to discharge batteries to export power to the power grid, to charge other batteries, and/or to apply power to the AC mains of a site/facility for use locally. As described herein, and of the other factors described above including the operations 504, 506, 508, 510, and/or 512 may be used in the operations 514 and/or 516. Once the determinations of the operations 514 and/or 516 are made, various batteries may be charged or discharged as desired according to the determinations.

FIG. 6 is a diagrammatic view of an example of a computing environment that includes a general-purpose computing system environment 100, such as a desktop computer, laptop, smartphone, tablet, or any other such device having the ability to execute instructions, such as those stored within a non-transient, computer-readable medium. Various computing devices as disclosed herein (e.g., the controller 174, a demand response module (DRM), or any other computing device in communication with the control 174) may be similar to the computing system 100 or may include some components of the computing system 100. Furthermore, while described and illustrated in the context of a single computing system 100, those skilled in the art will also appreciate that the various tasks described hereinafter may be practiced in a distributed environment having multiple computing systems 100 linked via a local or wide-area network in which the executable instructions may be associated with and/or executed by one or more of multiple computing systems 100.

In its most basic configuration, computing system environment 100 typically includes at least one processing unit 102 and at least one memory 104, which may be linked via a bus 106. Depending on the exact configuration and type of computing system environment, memory 104 may be volatile (such as RAM 110), non-volatile (such as ROM 108, flash memory, etc.) or some combination of the two. Computing system environment 100 may have additional features and/or functionality. For example, computing system environment 100 may also include additional storage (removable and/or non-removable) including, but not limited to, magnetic or optical disks, tape drives and/or flash drives. Such additional memory devices may be made accessible to the computing system environment 100 by means of, for example, a hard disk drive interface 112, a magnetic disk drive interface 114, and/or an optical disk drive interface 116. As will be understood, these devices, which would be linked to the system bus 306, respectively, allow for reading from and writing to a hard disk 118, reading from or writing to a removable magnetic disk 120, and/or for reading from or writing to a removable optical disk 122, such as a CD/DVD ROM or other optical media. The drive interfaces and their associated computer-readable media allow for the nonvolatile storage of computer readable instructions, data structures, program modules and other data for the computing system environment 100. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 100.

A number of program modules may be stored in one or more of the memory/media devices. For example, a basic input/output system (BIOS) 124, containing the basic routines that help to transfer information between elements within the computing system environment 100, such as during start-up, may be stored in ROM 108. Similarly, RAM 110, hard drive 118, and/or peripheral memory devices may be used to store computer executable instructions comprising an operating system 126, one or more applications programs 128 (which may include the functionality disclosed herein, for example), other program modules 130, and/or program data 122. Still further, computer-executable instructions may be downloaded to the computing environment 100 as needed, for example, via a network connection.

An end-user may enter commands and information into the computing system environment 100 through input devices such as a keyboard 134 and/or a pointing device 136. While not illustrated, other input devices may include a microphone, a joystick, a game pad, a scanner, etc. These and other input devices would typically be connected to the processing unit 102 by means of a peripheral interface 138 which, in turn, would be coupled to bus 106. Input devices may be directly or indirectly connected to processor 102 via interfaces such as, for example, a parallel port, game port, firewire, or a universal serial bus (USB). To view information from the computing system environment 100, a monitor 140 or other type of display device may also be connected to bus 106 via an interface, such as via video adapter 132. In addition to the monitor 140, the computing system environment 100 may also include other peripheral output devices, not shown, such as speakers and printers.

The computing system environment 100 may also utilize logical connections to one or more computing system environments. Communications between the computing system environment 100 and the remote computing system environment may be exchanged via a further processing device, such a network router 152, that is responsible for network routing. Communications with the network router 152 may be performed via a network interface component 154. Thus, within such a networked environment, e.g., the Internet, World Wide Web, LAN, or other like type of wired or wireless network, it will be appreciated that program modules depicted relative to the computing system environment 100, or portions thereof, may be stored in the memory storage device(s) of the computing system environment 100.

The computing system environment 100 may also include localization hardware 186 for determining a location of the computing system environment 100. In some instances, the localization hardware 156 may include, for example only, a GPS antenna, an MID chip or reader, a WiFi antenna, or other computing hardware that may be used to capture or transmit signals that may be used to determine the location of the computing system environment 100.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. A system comprising:
a direct current (DC) bus;
a plurality of battery chargers connected to the DC bus, wherein each of the plurality of battery chargers is configured to:
electrically connect to a first battery having a first nominal voltage;
supply first direct current (DC) power from the DC bus to the first battery at the first nominal voltage to charge the first battery;
electrically connect to a second battery having a second nominal voltage different from the first nominal voltage; and
supply second direct current (DC) power from the DC bus to the second battery at the second nominal voltage to charge the second battery.

2. The system of claim 1, wherein the DC bus has a third nominal voltage and each of the plurality of battery chargers is further configured to:
supply third direct current (DC) power to the DC bus at the third nominal voltage from the first battery; and
supply fourth direct current (DC) power to the DC bus at the third nominal voltage from the second battery.

3. The system of claim 2, wherein the third nominal voltage is different from the first nominal voltage and the second nominal voltage.

4. The system of claim 2, wherein the third nominal voltage is the same as one of the first nominal voltage or the second nominal voltage.

5. The system of claim 2, wherein each of the plurality of battery chargers comprises a direct current (DC) to direct current (DC) converter, wherein the DC to DC converter is configured to convert:
fifth direct current (DC) power from the DC bus at the third nominal voltage to the first nominal voltage to supply the first DC power to the first battery;
sixth direct current (DC) power from the DC bus at the third nominal voltage to the second nominal voltage to supply the second DC power to the second battery;
seventh direct current (DC) power from the first battery at the first nominal voltage to the third nominal voltage to supply the third DC power to the DC bus; and
eight direct current (DC) power from the second battery at the second nominal voltage to the third nominal voltage to supply the fourth DC power to the DC bus.

6. The system of claim 1, further comprising a renewable energy source input electrically connected to the DC bus and configured to receive third direct current (DC) power from the renewable energy source.

7. The system of claim 1, further comprising an inverter configured to:
receive third direct current (DC) power from the DC bus;
convert the third DC power to an alternating current (AC) power; and
output the AC power to a power grid or alternating current (AC) main power supply.

8. The system of claim 1, further comprising a rectifier configured to:
receive alternating current (AC) power from a power grid or alternating current (AC) main power supply;
convert the AC power to a third direct current (DC) power; and
output the third DC power to the DC bus.

9. The system of claim 1, further comprising a controller in communication with each of the plurality of battery chargers, wherein the controller is configured to:
receive battery characteristic information about the first battery from a first charger of the plurality of battery chargers;
determine, based on the battery characteristic information, that the first battery should no longer be used as a motive power battery for an electric vehicle (EV); and
transmit, to a user interface, a signal indicative of the determination that the first battery should no longer be used as the motive power battery.

10. A method of operating a battery charging system comprising a plurality of battery chargers configured to receive power from a direct current (DC) bus, the method comprising:
receiving, by a controller in communication with a first battery charger of the plurality of battery chargers, a charge state of a battery connected to the first battery charger;
determining, by the controller based on the charge state, that the battery is at less than a full charge level; and
transmitting, by the controller based on the determination that the battery is at less than the full charge level, a charge signal to the first battery charger configured to cause the first battery charger to charge the battery, wherein:
the DC bus has a first nominal voltage;
the battery has a second nominal voltage different than the first nominal voltage; and
the first battery charger is configured to receive first direct current (DC) power at the first nominal voltage from the DC bus, convert the first DC power to a second direct current (DC) power at the second nominal voltage, and output the second DC power to the battery.

11. The method of claim 10, further comprising transmitting, by the controller, a discharge signal to the first battery charger configured to cause the first battery charger to receive third direct current (DC) power from the battery at the second nominal voltage, convert the third DC power to a fourth direct current (DC) power at the first nominal voltage, and output the fourth DC power to the DC bus.

12. The method of claim 10, wherein the charge state is a first charge state received at the controller at a first time, and wherein the method further comprises:
receiving, by the controller at a second time, a second charge state of the battery connected to the first battery charger;
determining, based on the second charge state, that the battery should no longer be used as a motive power battery for an electric vehicle (EV); and
transmitting, to a user interface, a signal indicative of the determination that the battery should be used as a stationary battery permanently connected to at least one of the plurality of battery chargers.

13. The method of claim 12, wherein the signal is a first signal, and wherein the method further comprises:
receiving, by the controller at a third time, a third charge state of the battery connected to the at least one of the plurality of battery chargers;
determining, based on the third charge state, that the battery should no longer be used as the stationary battery; and
transmitting, to the user interface, a second signal indicative of the determination that the battery should no longer be used as the stationary battery.

14. The method of claim 10, further comprising determining, by the controller, a time window of a day during which the battery should be charged, wherein the controller controls transmission of the charge signal such that the first battery charger charges the battery only during the determined time window of the day.

15. The method of claim 10, further comprising determining, by the controller, whether to transmit the charge signal, a discharge signal, or no signal to the first battery charger based on at least one of first power available from a grid;
second power available from a renewable power source;
third power available from a plurality of other batteries connected to the DC bus via the plurality of battery chargers;
a first current price for exported power to the grid; or
a second current price imported power from the grid.

16. The method of claim 10, wherein the charge state is a first charge state, the battery is a first batten, the full charge level is a first full charge level, the charge signal is a first charge signal, and the method further comprises:
receiving, by the controller in communication with a second battery charger of the plurality of battery chargers, a second charge state of a second battery connected to the second battery charger;
determining, by the controller based on the second charge state, that the second battery is at less than a second full charge level; and
transmitting, by the controller based on the determination that the second battery is at less than the second full charge level, a second charge signal to the second battery charger configured to cause the second battery charger to charge the second battery, wherein:
the second battery has a third nominal voltage different than both the first nominal voltage of the DC bus and the second nominal voltage of the first battery; and
the second battery charger is configured to receive third direct current (DC) power at the first nominal voltage from the DC bus, convert the third DC power to a fourth direct current (DC) power at the third nominal voltage, and output the fourth DC power to the second battery.

17. A method of operating a battery charging system comprising a plurality of battery chargers configured to output power to a direct current (DC) bus, the method comprising:
receiving, by a controller in communication with a first battery charger of the plurality of battery chargers, a charge state of a battery connected to the first battery charger;
determining, by the controller based on the charge state, that the battery at a charge level sufficient to output power to the DC bus; and
transmitting, by the controller based on the determination that the battery is at the charge level, a discharge signal to the first battery charger configured to cause the first battery charger to discharge the battery, wherein:
the first battery has a first nominal voltage; and
the DC bus has a second nominal voltage different than the first nominal voltage;
the first battery charger is configured to receive first direct current (DC) power at the first nominal voltage from the battery, convert the first DC power to a second direct current (DC) power at the second nominal voltage, and output the second DC power to the DC bus.

18. The method of claim 17, further comprising determining, by the controller, whether to transmit a charge signal, the discharge signal, or no signal to the first battery charger based on at least one of:
first power available from a grid;
second power available from a renewable power source;
third power available from a plurality of other batteries connected to the DC bus via the plurality of battery chargers;
a first current price for exported power to the grid; or
a second current price imported power from the grid.

19. The method of claim 17, further comprising determining, by the controller, a time window of a day during which the battery should be discharged, wherein the controller controls transmission of the discharge signal such that the first batten charger discharges the battery only during the determined time window of the day.

20. The method of claim 17, wherein the charge state is a first charge state, the battery is a first battery, the charge level is a first charge level, the discharge signal is a first discharge signal, and the method further comprises:
receiving, by the controller in communication with a second battery charger of the plurality of battery chargers, a second charge state of a second battery connected to the second battery charger;
determining, by the controller based on the second charge state, that the second battery is at a second charge level sufficient to output power to the DC bus; and
transmitting, by the controller based on the determination that the second battery is at less than the second full charge level, a second discharge signal to the second battery charger configured to cause the second battery charger to discharge the second battery, wherein:
the second battery has a third nominal voltage different than both the first nominal voltage of the DC bus and the second nominal voltage of the first battery; and
the second battery charger is configured to receive third direct current (DC) power at the third nominal voltage from the second battery, convert the third DC power to a fourth direct current (DC) power at the first nominal voltage, and output the fourth DC power to the DC bus.
